(19) United States
(12) Patent Application Publication
(10) Pub. No.: US 2007/0227107 A1
(43) Pub. Date: Oct. 4, 2007

(54) Air conditioning apparatus

(75) Inventors: Koji Ito, Nagoya-city (JP); Kenichi Kato, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/732,098

(22) Filed: Apr. 2, 2007

(30) Foreign Application Priority Data
Apr. 3, 2006 (JP) 2006-101932

(51) Int. Cl. B01D 50/00

(52) U.S. Cl. 55/385.3

(57) ABSTRACT

Air flow from an internal air/external air switching unit 10 passes through a by-pass passage 63 and flows into a heater core 41. Warm air is blown out from the heater core 41 and flows into a deodorizing filter 60. In the deodorizing filter 60, odor components are separated from a charcoal filter by the heat of the warm air, the odor components then flowing in the order of a discharging passage 66→an external air inlet port 12 of a vent switching unit 50→an external air intake port, and being discharged out of the vehicle room. Thus, by simply providing the by-pass passage 63, the discharging passage 66, and the doors 61, 68, the same heater unit 41 and blower unit 20 as in prior art can be used to separate odor components from the deodorizing filter.

### BACKGROUND OF THE INVENTION

1. Technical Field of the Invention

The present invention relates to a vehicle air conditioning apparatus comprising a physical adsorption type filter for collecting odor components.

2. Description of the Related Art

Conventionally, a vehicle air conditioning apparatus comprising a charcoal filter as a physical adsorption type filter for collecting odor components in air is known (see, for example, Japanese Patent Publication No. 2005-321114).

In such an apparatus, in addition to an usual heat exchanger and blower for adjusting the temperature of blown-out air, there is provided a dedicated heating device and a dedicated blower for purifying a charcoal filter. This dedicated heating device and blower are used to generate warm air, which is used to separate the odor components collected by the charcoal filter from the charcoal filter, and the odor components thus separated are discharged together with the warm air to the outside of vehicle room.

Since the above-described air conditioning apparatus comprises, besides a conventional blower and heat exchanger for adjusting the temperature of the blown-out air, an additional heating device and an additional blower dedicated for separating odor components from a charcoal filter, the construction of the air conditioning apparatus becomes more complicated than usual.

### SUMMARY OF THE INVENTION

In view of the above-described problem, it is an object of the present invention to provide a vehicle air conditioning apparatus that permits a filter to be purified by employing an apparatus of relatively simple construction utilizing the constituents of a conventional air conditioning apparatus.

In order to obtain the above object, in accordance with the present invention, a vehicle air conditioning apparatus comprises a by-pass passage (63) which guides the blown-out air from a blower, so as to by-pass a heat exchanger for cooling, a physical adsorption type filter, and a heat exchanger for heating, to a site upstream of the vents, by-pass passage opening/closing means (61) for opening and closing the by-pass passage, and a communicating hole (65) formed separately from the vents in the casing in communication with the outside of the vehicle, whereby, in purging operation mode for purging the odor components adsorbed by the physical adsorption type filter, the vent is closed by a vent opening/closing means, and the by-pass passage is opened by the by-pass passage opening/closing means, so that the blown-out air from the blower flows through the by-pass passage, the heat exchanger for heating, the physical adsorption type filter, and the communicating hole in this order so as to purge the odor components that have been adsorbed by the physical adsorption type filter using the heat of warm air heated by the heat exchanger for heating and to discharge the odor components through the communicating hole to the outside of the vehicle.

With the above-described invention, odor components are separated from the filter by simply providing the by-pass passage opening/closing means (61), the by-pass passage (63) and the communicating hole (65) and by using the same heat exchanger for heating and blower as in the conventional art. Thus, it becomes possible to purify the filter using an apparatus of relatively simple construction.

Here, a physical adsorption type filter refers to a filter composed of porous material such as charcoal, zeolite, etc., which has a multiplicity of microscopic pores and which deodorizes air by causing the odor components in air to be adsorbed by the microscopic pores of the porous material. The expression “purge the odor components adsorbed by the physical adsorption type filter” means that the odor components adsorbed by the physical adsorption type filter are removed from the physical adsorption type filter.

In the present invention, a drain hole (32) for discharging condensed water from the heat exchanger for cooling to the outside of the vehicle room is provided in the casing of the air conditioner, and the drain hole acts as a communicating hole for discharging, condensed water, as well as the odor components together with the warm air to the outside of the vehicle room.

Therefore, the same drain hole as used in the prior art can be employed as the communicating hole to thereby further simplify the construction of the apparatus.

Further, in the present invention, an air mixing door is used such that, while the cold air by-pass passage is closed, all of the cold air that has passed through the physical adsorption type filter flows into the heat exchanger for heating.

Therefore, the maximum amount of heat is imparted by the heat exchanger for heating to the cold air that has passed through the physical adsorption type filter, and warm air at high temperature can be generated from the heat exchanger for heating in order to achieve good separation of the odor components from the physical adsorption type filter.

The present invention is constructed such that, the purging operation mode can be implemented when the temperature detected by the temperature sensor is equal to or higher than a predetermined temperature, and the purging operation mode cannot be implemented when the temperature detected by the temperature sensor is lower than the predetermined temperature.

Therefore, since the purging operation mode is implemented only when the temperature detected by the temperature sensor is equal to or higher than the predetermined temperature, warm air at high temperature can be generated from the heat exchanger for heating whenever the purging operation mode is implemented. Thus, at the time of implementing the purging operation mode, the odor components can always be satisfactorily separated from the physical adsorption type filter.

Reference numerals indicated herein in parentheses for various means and in the claims show the corresponding specific means described in the embodiments to be described later.

The present invention may be more fully understood from the description of the preferred embodiments of the invention, as set forth below, together with the accompanying drawings.

### BRIEF DESCRIPTION OF THE DRAWINGS

In the drawings:

FIG. 1 is a sectional view showing the construction of a vehicle air conditioning apparatus according to an embodiment of the present invention;

FIG. 2 is a view showing the vehicle air conditioning apparatus of FIG. 1 as seen in the direction of the arrow A in FIG. 1;

FIG. 3 is a view showing the electrical construction of the vehicle air conditioning apparatus of FIG. 1; and

FIG. 4 is a sectional view useful for explaining the operation of the vehicle air conditioning apparatus of the above embodiment.

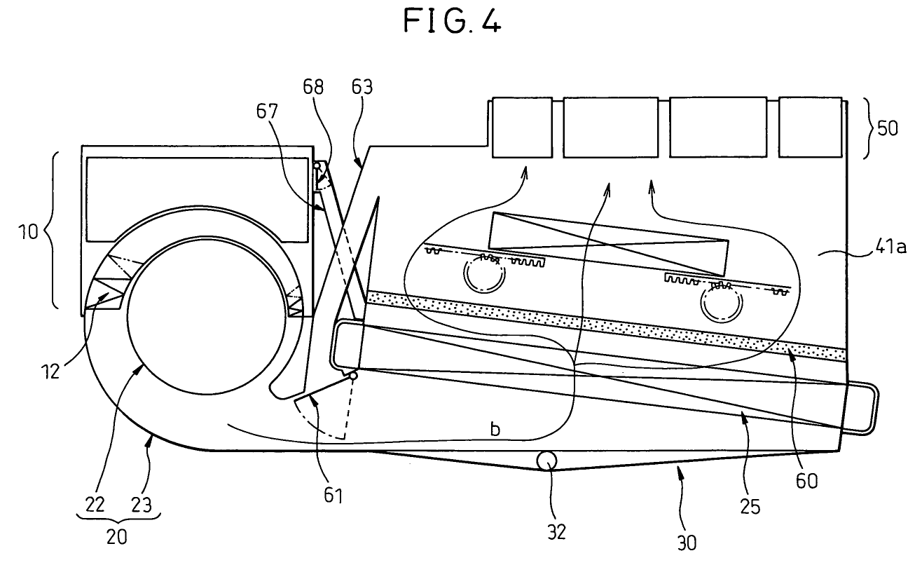

### DESCRIPTION OF THE PREFERRED EMBODIMENTS

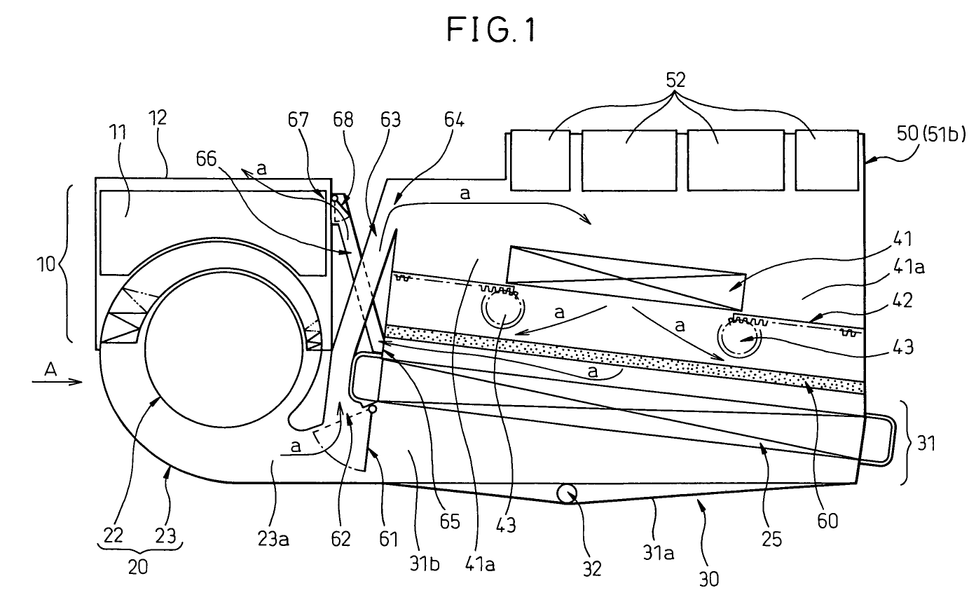

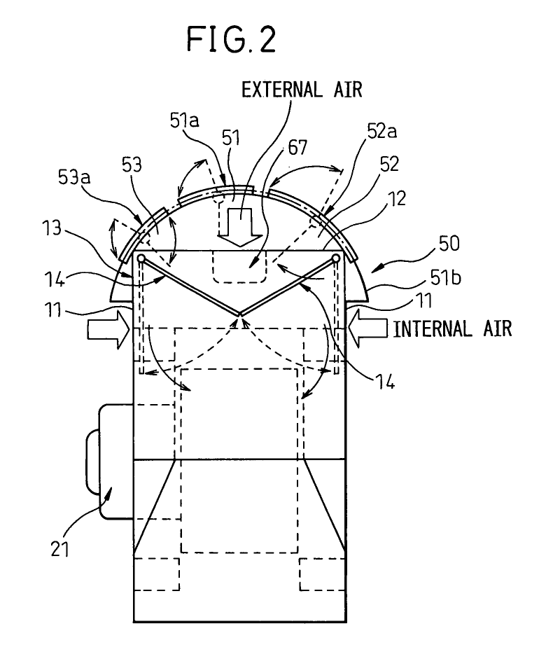

FIG. 1 is a sectional plan view showing an interior unit of a vehicle air conditioning apparatus according to the present invention, and FIG. 2 is a view showing the interior unit of FIG. 1 as seen in the direction of the arrow A in FIG. 1.

As shown in FIG. 1, the vehicle air conditioning apparatus 10 is comprised of an internal/external air switching unit 10, a blower unit 20 and an air conditioning unit 30. The air conditioning unit 30 has the center-positioned layout in that it is disposed, inside the instrument panel in the front portion of the vehicle, generally in the center portion in the left/right direction of the vehicle. The blower unit 20 is disposed in an off-set position in front of the front passenger seat that is lateral relative to the air conditioning unit 30 in the left/right direction of the vehicle, and the internal/external air switching unit 10 is disposed on the upper side relative to the blower unit 20 in the up/down direction.

As shown in FIG. 2, a unit casing 13 having two internal air inlet ports 11 for introducing air into the vehicle room and an external air inlet port 12 for introducing external air from the external air intake port is provided in the internal/external air switching unit 10. The external air intake port is a well-known port provided in an engine room. Two internal/external air switching doors 14 are provided in the unit casing 13 for selectively opening/closing the internal air inlet port 11 and the external air inlet port 12, respectively. Here, when the two internal/external air switching doors 14 are in a first state (shown as a solid line in FIG. 2), the external air intake port is closed and two internal air inlet ports 11 are opened. When the two internal/external air switching doors 14 are in a second state (shown as a chain line in FIG. 2), the two internal air inlet ports 11 are closed and the external air intake port is opened. In the present embodiment, a plate door is used as an internal/external air switching doors 14.

The blower unit 20 as shown in FIG. 1 has a well-known construction comprising a vane wheel having a multiplicity of wings (blades) arranged in annular form, a blower motor 21 for rotationally driving the blower fan 22 (see FIG. 2) and a helical shaped scroll case 23 containing the vane wheel 22. Symbol S in FIG. 2 denotes a dust collection filter.

The air conditioning unit 30 comprises an air conditioner casing 31a made of resin, and an air intake port is formed in the air conditioner casing 31a. This air intake port is connected to an air outlet port 23a of the scroll casing 23. In the air conditioner casing 31a, blown air is introduced from the air outlet port 23a of the scroll casing 23, and flows upwards in a vertical direction.

In the air conditioner casing 31a, a heat exchanger for cooling 25 is disposed on the lower side in a vertical direction. The heat exchanger for cooling 25 together with a compressor, a condenser and pressure reducing means comprises a well-known refrigeration cycle for cooling the air in the air conditioner casing 31a.

In the air conditioner casing 31a, on the lower side of the heat exchanger for cooling 25 in a vertical direction, there is provided a drain hole 32. The drain hole 32 drains the condensed water of the heat exchanger for cooling 25 out of the vehicle room. On the lower side of the heat exchanger for cooling 25 in a vertical direction, there is provided a thin plate-shaped deodorizing filter 60. The deodorizing filter 60 is composed of a porous material such as charcoal, zeolite, etc., having a multiplicity of microscopic pores, and is a well-known physical adsorption type filter for deodorizing air by causing odor components (such as acetaldehyde) in the air to be adsorbed in the microscopic pores of the porous material.

A heater core 41 is disposed above the deodorizing filter 60. The heater core 41 is a heat exchanger for heating the air in the air conditioner casing 31a using engine cooling water (warm water) flowing into it as a heat source. In the air conditioner casing 31a, on both sides of the heater core 41 in the vehicle width direction, by-pass passages 41a are provided for flowing air that has passed through the deodorizing filter 60 while by-passing the heater core 41. Two air mixing doors 42 are provided between the heater core 41 and the deodorizing filter 60.

The two air mixing doors 42 are slidably supported on drive gears 43, respectively. The two air mixing doors 42 change, by respective extent of opening, the ratio of the wind air flow rate to the heater core 41 to the wind air flow rate to the by-pass passages 41a to thereby adjust the amount of heat imparted to the air that has passed through the deodorizing filter 60 by the heater core 41. In this way, the two air mixing doors 42 can adjust the temperature of the air blown into the vehicle room.

A vent switching unit 50 is provided on the upper side of the air conditioner casing 31a, and on the casing 51b of the vent switching unit 50, there are formed a face vent 51, a foot vent 52, and a defroster vent 53, as shown in FIG. 2. On the upstream side of the vents 51, 52, 53, there are provided mode doors 51a, 52a, 53a for respectively opening/closing the vents 51, 52, 53. When the mode doors 51a, 52a, 53a are in a first state (shown as a solid line in FIG. 2), the vents 51, 52, 53 are closed, respectively, and when the mode doors 51a, 52a, 53a are in a second state (shown as a chain line in FIG. 2), the vents 51, 52, 53 are respectively open.

The foot vent 52 (and face vent 51) is provided in four vents each venting in different directions as shown in FIG. 1 (only 4 foot vents are shown in FIG. 1), although this is omitted in FIG. 2.

An air intake port 62 of the by-pass passage 63 is connected to the air intake port of the air conditioner casing 31a, and an air discharging port 64 of the by-pass passage 63 is connected between the heater core 41 and the vent 51, 52, 53 in the air conditioner casing 31a. The by-pass passage 63 by-passes the heat exchanger for cooling 25, the deodorizing filter 60, and the heater core 41, and guides the blown air from the scroll casing 23 to a site between the heater core 41 and the vents 51, 52, 53 (a site upstream of the vents). On the upstream side of the air intake port 62 of the by-pass passage 63, a switching door 61 is rotatably supported. The switching door 61 is the by-pass passage opening/closing means for opening/closing the air intake port 62 of the by-pass passage 63 and the air inflow passage 31b for the heat exchanger for cooling 25. When the switching door 61 is in a first state (shown as a solid line in FIG. 1), the air intake port 62 of the by-pass passage 63 is opened and the air inflow passage 31b for the heat exchanger for cooling 25 is closed. When the switching door 61 is in a second state (shown as a chain line in FIG. 1), the air intake port 62 of the by-pass passage 63 is closed and the air inflow passage 31b for the heat exchanger for cooling 25 is opened. The air inflow passage 31b is a passage for introducing the air from the air outlet port 23a of the scroll casing 23 to the heat exchanger for cooling 25. In this embodiment, a plate door is used as the switching door 61.

In the air conditioner casing 31a, between the heat exchanger for cooling 25 and the deodorizing filter 60, there is further provided a discharging port 65 as a communicating hole. The discharging port 65 is in communication with an opening 67 (see FIG. 2) of the unit casing 13 via a discharging passage 66. The opening 67 is provided in the unit casing 13 nearer to the external air inlet port 12 than the internal/external air switching door 14, whereby the discharging port 65 of the air conditioner casing 31a comes into communication with the external air intake port via the discharging passage 66 and the external air inlet port 12. A shielding door 68 is rotatably supported on the discharging passage 66. When the shielding door 68 is in a first state (as shown in solid line in FIG. 1), the discharging passage 66 is opened, and when the shielding door 68 is in a second state (shown as a chain line in FIG. 1), the discharging passage 66 is closed.

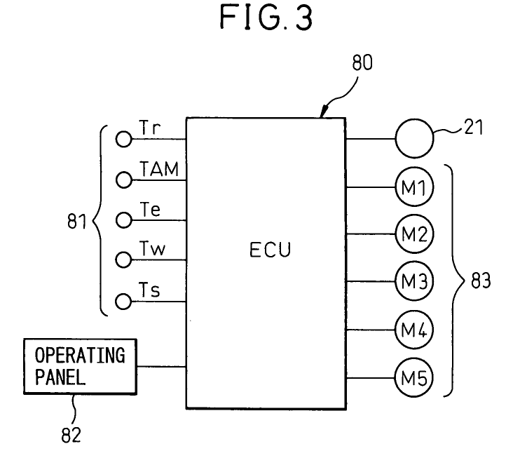

FIG. 3 is a schematic view showing the electrical construction of a vehicle air conditioning apparatus. The vehicle air conditioning apparatus comprises an electronic controller (denoted as ECU 80 in the Figure). The electronic controller 80 is composed of a microprocessor, memory, etc., and controls a blower motor 21 and a motor group 83 based on the detection signal from a sensor group 81 and the operating signal from an operating panel 82.

The sensor group 81 is composed of various sensors for detecting the air temperature Te of the vent air of the heat exchanger for cooling 25, the external air temperature TAM outside the vehicle room, the internal air temperature Tr in the vehicle room, the amount of solar radiation Ts irradiated into the vehicle room, and the temperature of warm water flowing into the heater core 41, etc., respectively. The operating panel 82 comprises a temperature setter for setting the temperature in the vehicle room, a wind flow rate setter for setting the wind flow rate of the blower unit 20, an AC switch for switching the compressor on and off, and a purifying switch for implementing the filter purifying operation mode.

The motor group 83 is composed of a motor M1 for driving the internal/external air switching door 14, a motor M2 for driving the air mixing door 42, a motor M3 for driving the mode doors 51a, 52a, 53a via a link mechanism, a motor M4 for driving the switching door 61, and a motor M5 for driving the shielding door 68.

Next, the operation of the vehicle air conditioning apparatus according to the present embodiment will be described.

The vehicle air conditioning apparatus according to the present embodiment is adapted to implement an air conditioning operation mode and a filter purifying operation mode (purging operation mode). The air conditioning operation mode and the filter purifying operation mode will be separately described below.

(Air Conditioning Operation Mode)

The air conditioning operation mode is implemented when the AC switch on the operating panel is turned on, and the electronic controller 80 controls the motors M1, M2, M3, and the blower motor 21 based on the target outflow air temperature TAO, whereby at least one of the internal air inlet port 11 and the external air inlet port 12 is opened by the internal/external air switching door 14, and the extent of opening of the air mixing door 42 is adjusted in relation to the target outflow air temperature TAO, and at least one of the vents 51, 52, 53 is opened by the mode doors 51a, 52a, 53a. In addition, the wind flow rate based on the target outflow air temperature TAO is generated from the blower unit 20. The target outflow air temperature TAO is a well-known temperature calculated from the air temperature Te of the vent air of the evaporator, the external air temperature TAM, the internal air temperature Tr, the amount of solar radiation Ts, and the warm water temperature Tw.

Further, the electronic controller 80 controls the motors M4, M5 for operating the switching door 61 and the shielding door 68, such that the air intake port 62 of the by-pass passage 63 is closed and the air inflow passage 31b from the heat exchanger for cooling 25 is opened by the switching door 61. The shielding door 68 shuts down the discharging passage 66.

In this case, the blower unit 20 introduces air from one of the internal air inlet port 11 and the external air inlet port 12 of the internal/external air switching unit 10, and the introduced air is blown into the air intake port of the air conditioning unit 30, and the blown-out air flows in the air conditioning unit 30 as shown by the arrow b in FIG. 2. FIG. 2 is essentially the same as FIG. 1, except that some reference numerals are omitted so as to facilitate visualization of the arrow.

Specifically, the air blown out from the blower unit 20 passes through the heat exchanger for cooling 25 and then is blown into the deodorizing filter 60. Odor components in the inflow air are collected by the deodorizing filter 60. Then, the air that has passed through the deodorizing filter 60 is, after passing through the heater core 41 or the by-pass passage 41a, blown into the vehicle room from one of the vents 51˜53.

(Filter Purifying Operation Mode)

When the purifying switch on the operating panel is turned on, and if the temperature of the warm water Tw is equal to or higher than a predetermined temperature (for example, 60° C.), the filter purifying operation mode is implemented, and if the temperature of the warm water Tw is lower than a predetermined temperature (for example, 60° C.), the filter purifying operation mode is not implemented. In the filter purifying operation mode, the electronic controller 80 controls the motors M1, M2, M3, M4, M5 for operating the doors 14, 42, the mode doors 51a, 52a, 53a, the switching door 61 and the shielding door 68 as follows.

Specifically, two internal/external air switching doors 14 are used to open the internal air inlet port 11 and close the external air inlet port 12. Two air mixing doors 42 are set to the maximum heating position. That is, the port of the two by-pass passages 41a is completely closed. The mode doors 51a, 52a, 53a completely shut the vents 51, 52, 53. The switching door 61 opens the air intake port 62 of the by-pass passage 63, closes the air inflow passage 31b of the heat exchanger for cooling 25, and the shielding door 68 opens the discharging passage 66.

When the electronic controller 80 rotates the blower motor 21 at a predetermined specified rotational speed, the blower unit 20 introduces internal air from the internal air inlet port 11 of the internal/external air switching unit 10, and the internal air is blown to the air intake port of the air conditioner casing 31a and flows as shown by the arrow a in FIG. 1. Specifically, the internal air passes through the by-pass passage 63, and all the air flow that has passed through the by-pass passage 63 flows into the heater core 41. Here, a maximum amount of heat is imparted to the air flow by the heater core 41 in order to generate warm air.

Then, the warm air that is blown out from the heater core 41 passes through the deodorizing filter 60. Here, odor components are separated (that is, purged) from the charcoal in the deodorizing filter 60 by the heat of the warm air. The odor components are transported together with the warm air in the order of the discharging passage 66→the external air inlet port 12 of the vent switching unit 50→external intake port, and discharged out of the vehicle room.

In accordance with the present embodiment as has been described above, simply by providing the by-pass passage 63, the discharging passage 66, the doors 61, and 68, odor components can be separated from the deodorizing filter 60 using the same heater unit 41 and blower unit 20 as in prior art. Thus, it is possible to purify the deodorizing filter 60 using a relatively simple construction.

Since in the filter purifying operation mode in the present embodiment, the air mixing door 42 is set at the maximum heating position, the maximum amount of heat is imparted from the heater core 41 to the cold air flow and warm air at high temperature can be generated from the heater core 41. Thus, odor components can be effectively separated from the deodorizing filter 60.

In this embodiment, the heater core 41 heats the cold air that has passed through the deodorizing filter 60 based on the cooling water of the driving engine, such that the filter purifying operation mode is implemented only when the temperature of the cooling water of the driving engine is equal to or higher than a predetermined temperature. Therefore, whenever the filter purifying operation mode is implemented, warm air at high temperature can be generated from the heater core 41. Thus, whenever the filter purifying operation mode is implemented, odor components can be effectively separated from the deodorizing filter 60.

In the above-described embodiment, an example is described in which, at the time of implementing the filter purifying operation mode, internal air is introduced by the internal/external air switching unit 10. However, the invention is not limited to this example, and external air may be introduced by the internal/external air switching unit 10.

In the above-described embodiment, an example is described in which the discharging port 65 is provided between the heat exchanger for cooling 25 and the deodorizing filter 60 in the air conditioner casing 31a. However, the invention is not limited to this example, and the discharging port may be provided at any location in “the air passage 31 for passing the wind air flow of the blower unit 20 via the heat exchanger for cooling 25 between the switching door 61 and the deodorizing filter 60”.

For example, the drain hole 32 of the air conditioner casing 31a may be used as the discharging port 65, and in the filter purifying operation mode, odor components may be discharged from the drain hole 32 together with the warm air to the outside of the vehicle room. Thus, the same drain hole 32 as in prior art can be used as the air discharging port, so that the discharging passage 66 used in the above-described embodiment can be omitted, and the construction can be further simplified compared to the above-described embodiment.

In the above-described embodiment, an example is described in which a slide door is used as the air mixing door 42. The present invention is not limited to this example, since various doors such as a plate door, a film door, etc., may be used.

In the above-described embodiment, an example is described in which the air mixing door 42 is used to adjust the temperature of the vent air. The present invention is not limited to this example, since a reheating method may be employed to adjust the amount of warm water flowing into the heater core 41 to thereby adjust the temperature of the vent air.

While the invention has been described by reference to specific embodiments chosen for purposes of illustration, it should be apparent that numerous modifications could be made thereto, by those skilled in the art without, departing from the basic concept and scope of the invention.

What is claimed is:

1. A vehicle air conditioning apparatus comprising:
an air conditioner casing;
a blower for generating air flow in said air conditioner casing;
vents formed on said casing for venting the air flow from said blower into a vehicle room;
a heat exchanger for cooling provided in said casing for cooling the air flow from said blower;
a heat exchanger for heating provided in said casing for heating the air flow from said blower;
a physical adsorption type filter provided at a site in said casing between said heat exchanger for cooling and said heat exchanger for heating for collecting odor components contained in the air flow from said blower;
vent opening/closing means for opening/closing said vents, which, when the air flow is vented from said vents, lets the air flow from said blower through said heat exchanger for cooling, said physical adsorption type filter, said heat exchanger for heating, and said vents in this order:
a by-pass passage which guides the air flow from said blower so as to by-pass said heat exchanger for cooling, said physical adsorption type filter, and said heat exchanger for heating, to a site on the upstream side of said vents;
by-pass passage opening/closing means for opening/closing said by-pass passage; and
a communicating hole formed on said casing separately from said vents in communication with the outside of the vehicle room;
characterized in that, in purging operation mode for purging of odor components adsorbed by said physical adsorption type filter, said vents are closed by said vents opening/closing means and said by-pass passage is opened by said by-pass passage opening/closing means so as to let flow air flow from said blower through said by-pass passage, said heat exchanger for heating, said physical adsorption type filter, and said communicating hole in this order, whereby the odor components adsorbed by said physical adsorption type filter are purged by the heat of the warm air heated by said heat exchanger for heating, and the odor components are discharged from said communicating hole out of the vehicle room.

2. A vehicle air conditioning apparatus according to claim 1, wherein said by-pass passage opening/closing means, in a first state, close a first air passage between said blower and said heat exchanger for cooling, and open said by-pass passage, and in a second state, open the first air passage between said blower and said heat exchanger for cooling, and close said by-pass passage.

3. A vehicle air conditioning apparatus according to claim 1, further comprising:
an internal air inlet port for introducing internal air into said air conditioner casing, an external air inlet port for introducing external air into said air conditioner casing, and a switching door for closing one and opening the other of said internal air inlet port and external air inlet port;
a discharging passage for communicating said communicating hole with said external air intake port; and
a discharging door for opening/closing said discharging passage;
wherein, when air flow is vented from said vents, with said discharging passage closed by said discharging door, said blower introduces air from one of said internal air inlet port and said external air inlet port in accordance with opening/closing of said switching door; and
wherein, in said purging operation mode, with said discharging passage closed by said discharging door, said odor components purged from said physical adsorption type filter are discharged out of the vehicle room via said discharging passage and said external air intake port.

4. A vehicle air conditioning apparatus according to claim 1, wherein a drain hole is provided on said air conditioner casing for draining the condensed water of said heat exchanger for cooling; and
wherein said drain hole is adapted to act, in addition to draining the condensed water, as said communicating hole to discharge said odor components together with the warm air out of the vehicle room.

5. A vehicle air conditioning apparatus according to claim 1, further comprising:
a cool air by-pass passage for guiding air flow from said blower so as to by-pass said heat exchanger for heating; and
an air mixing door for adjusting the amount of heat imparted to the air flow from said blower from said heat exchanger for heating by changing the ratio of the amount of air inflow into said cool air by-pass passage and the amount of air inflow into said heat exchanger for heating;
wherein, in said purging operation mode, with said cool air by-pass passage closed by said air mixing door, all of the air flow from said blower flows into said heat exchanger for heating.

6. A vehicle air conditioning apparatus according to claim 5, wherein said heat exchanger for heating heats the air flow from said blower based on the cooling water of the driving engine, and wherein the apparatus further comprises a temperature sensor for detecting the temperature of the cooling water of said driving engine, the apparatus being adapted to implement said purging operation mode when the temperature detected by said temperature sensor is equal to or higher than a predetermined temperature, and not to implement said purging operation mode when the temperature detected by said temperature sensor is lower than the predetermined temperature.
